(19) United States
(12) Patent Application Publication
(10) Pub. No.: US 2007/0050549 A1
(43) Pub. Date: Mar. 1, 2007

(54) Method and system for managing cacheability of data blocks to improve processor power management

(76) Inventor: Gary J. Verdun, Georgetown, TX (US)

Correspondence Address: Brian W. Peterman;O'KEEFE, EGAN & PETERMAN, LLP, Building C, Suite 200, 1101 Capital of Texas Highway South, Austin, TX, 78746, US

(21) Appl. No.: 11/217,023

(22) Filed: Aug. 31, 2005

(51) Int. Cl. G06F 12/00

(52) U.S. Cl. 711/118

(57) ABSTRACT

Systems and methods are disclosed for managing cacheability of data blocks to improve processor power management. Data can be intelligently moved between cache memory and non-cache memory based upon expected processing needs. Alternatively, the data can remain in the same memory space, and the memory designation can be intelligently managed from a cache memory to non-cache memory designation and/or from non-cache memory to cache memory designation depending upon the expected processing needs. In addition, both data movement and memory space re-designation can be utilized in conjunction. By intelligently managing the cacheability of the memory space holding the data blocks, processing efficiency and power management efficiency can be improved, particularly for bus master devices and related circuitry.

### TECHNICAL FIELD OF THE INVENTION

This invention relates to memory management techniques in information handling systems and to techniques for improving processor power management in information handling systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Processors or central processing units (CPUs) for information handling systems such as desktop and portable computers typically utilize cache memories to improve operational efficiency. Because the cache memory works at considerably faster speeds than non-cache memory, CPU operational speed can be improved by storing within the cache memory often used data or data requiring significant processing. When a memory access is required, a cache snoop operation is typically performed to determine if the desired data is within the cache memory. If so, the cache memory is accessed. If not, then non-cache memory is accessed.

Information handling systems also utilize various other techniques for improving the performance of devices and circuits within the system. One such technique is called “bus mastering.” This bus mastering technique implements logic circuitry on the motherboard for the information handling system that, when configured properly with other elements of the system, can reduce the CPU's work of retrieving and/or storing data. For example, IDE Bus Mastering has been implemented to improve accesses to Bus Master IDE devices such as hard disk drives or other IDE devices that have been configured to operate with IDE Bus Mastering protocols. In addition, PCI Bus Mastering circuitry and related PCI cards and devices have been utilized in information handling systems to improve the processing efficiency of CPUs, for example, by allowing for memory transfers to occur without the need for the CPU to be involved. With bus mastering, therefore, PCI devices can gain access to the PCI bus through an arbitration process and master the bus transaction directly, as opposed to waiting for the host CPU to service the device, which results in a reduction of overall latency on servicing input/output (I/O) transactions. Next generation, PCIe buses will also have bus mastering due to the advantages it provides. In short, bus mastering provides circuitry and protocols for efficiently handling the flow of data through an information handling system.

For many information handling systems, including portable systems, processor power management is also a significant issue. For example, processor power management in portable computers utilizes reduced voltage states for the processor. These reduced voltage states, however, preclude the ability to perform cache snoop operations. Many data operations, however, including those using bus master peripheral devices, often require the processor or CPU within the system to do some processing operations on blocks of data. And many of these processing operations are often best accomplished from a performance and speed perspective if the data were stored in the cache memory. Such data processing operations may be, for example, encryption, decryption, compression, decompression, encoding, decoding, etc. After being processed by the CPU, the data is then often used in such a way that it would be preferable for the data to reside in non-cache memory. For example, a bus master device will often utilize the processed data in such a way that if the data were not cached the bus master accesses would not wake the processor. In other words, for CPU performance, it is desirable for the data to be cached, and for power management, it is desirable for the data not to be cached.

In current systems, however, data blocks are either cached or not cached. As such, either CPU processing performance or CPU power management will suffer inefficiencies depending upon whether the data being processed has been placed in memory designated as cache memory space or in memory designated as non-cache memory space.

### SUMMARY OF THE INVENTION

The present invention provides systems and methods for managing cacheability of data blocks to improve processor power management. Data can be intelligently moved between cache memory and non-cache memory based upon expected processing needs. Alternatively, the data can remain in the same memory space, and the memory space designation can be intelligently managed from a cache memory to non-cache memory designation and/or from non-cache memory to cache memory designation depending upon the expected processing needs. In addition, both data movement and memory space re-designation can be utilized in conjunction, if desired. By intelligently managing the cacheability of the memory space holding the data blocks, processing efficiency and power management efficiency can be improved, particularly for bus master devices and related circuitry.

In one embodiment, the present invention is a method for managing cacheability of data blocks within an information handling system, including providing a device coupled through a bus to a processor within an information handling system with the processor having at least one low power state, receiving a data stream with the device, determining whether processing by the processor is needed for the data stream, storing a data block from the data stream in cacheable memory space if processing is needed by the processor, processing the data block with the processor if processing is needed, moving the data block to non-cacheable memory space once the processing by the processor is complete, and accessing the processed data block with the device while allowing the processor to stay in a low power state. In addition, the device can be a bus master device. The data stream can be video data, audio data, or both, including compressed data. Software operating on the processor can perform the determining, storing and moving steps. And a memory control hub can perform the determining, storing and moving steps. In addition, the method can include performing cache snoop operations when the data block is within cacheable memory space. As described below, other features and variations can be implemented, if desired, and related systems can be utilized, as well.

In another embodiment, the present invention is a method for managing cacheability of data blocks within an information handling system, including providing a device coupled through a bus to a processor within an information handling system with the processor having at least one low power state, receiving a data stream with the device, determining whether processing by the processor is needed for the data stream, storing a data block from the data stream in memory space, designating the memory space as cacheable if it is not already designated as cacheable if processing is needed for the data block, processing the data block with the processor if processing is needed, designating the cacheable memory space as non-cacheable memory space once the processing by the processor is complete, and further processing the processed data block with the device while allowing the processor to stay in a low power state. In addition, the device can be a bus master device. The data stream can be video data, audio data, or both, including compressed data. Software operating on a central processing unit can perform the determining, storing and moving steps. And a memory control hub can perform the determining, storing and designating steps. In addition, the method can include performing cache snoop operations when the data block is within cacheable memory space. As described below, other features and variations can be implemented, if desired, and related systems can be utilized, as well.

In a still further embodiment, the present invention is an information handling system having data block cacheability management including a processor having at least one low power mode and an on-chip cache, a memory having memory spaces capable of being designated as cacheable memory space or non-cacheable memory space, a device configured to receive and process a data stream including a plurality of data blocks, and a memory control hub coupled to the processor, the memory and the device. The memory control hub includes a data block cache manager configured to cause data blocks from the data stream needing to be processed by the processor to be in cacheable memory space and to cause these data blocks to be in non-cacheable memory space after they are processed. The processor is thereby allowed to stay in a low power state while the device is accessing the processed data block in the non-cacheable memory space. In addition, the memory control hub can be configured to move data blocks between memory space designated as cacheable memory space and non-cacheable memory space depending upon processing needs for the data blocks. The memory control hub can also be configured to change the memory space designation between a cacheable memory space designation and a non-cacheable memory space designation depending upon processing needs for the data blocks. Still further, the system can also include a device driver configured to be operated on the processor and to perform some or all of the operations of the data block cache manager. As described below, other features and variations can be implemented, if desired, and related methods can be utilized, as well.

### DESCRIPTION OF THE DRAWINGS

It is noted that the appended drawings, illustrate only exemplary embodiments of the invention and are, therefore, not to be considered limiting of its scope, for the invention may admit to other equally effective embodiments.

FIG. 1 is a block diagram for an information handling system including a data block cache manager according to the present invention.

FIG. 2A is a flow diagram for an embodiment in which data is intelligently moved between cacheable memory and non-cacheable memory in order to improve processor power performance with respect to data handling by bus master devices.

FIG. 2B is a flow diagram for an embodiment in which allocated memory spaces are intelligently moved between cacheable and non-cacheable designations in order to improve processor power performance with respect to data handling by bus master devices.

### DETAILED DESCRIPTION OF THE INVENTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a server computer system, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

The present invention provides systems and methods for managing cacheability of data blocks to improve processor power management. As discussed in more detail below, when a bus master device requires CPU processing, the processor or CPU reads a data block into cacheable memory space or begins with the data block already in cacheable memory space. The CPU then processes and modifies the data block as required. At the end of processing operation, the data or data block is then copied or written back to a new non-cacheable memory address space. Alternately, the memory space holding the data block can be changed from a cacheable designation to a non-cacheable designation. The bus master device is then signaled to perform its operation from this non-cacheable memory space and, therefore, does not interfere with CPU sleep states as it accesses the data. As set forth above, a bus master device is a device for which bus accesses are managed according to a bus access protocol to improve system performance. It is also noted that both data movement and memory space re-designation can be utilized in conjunction, if desired, to provide that data blocks are cached when CPU processing is needed and are not cached when CPU processing is not needed or has already been completed.

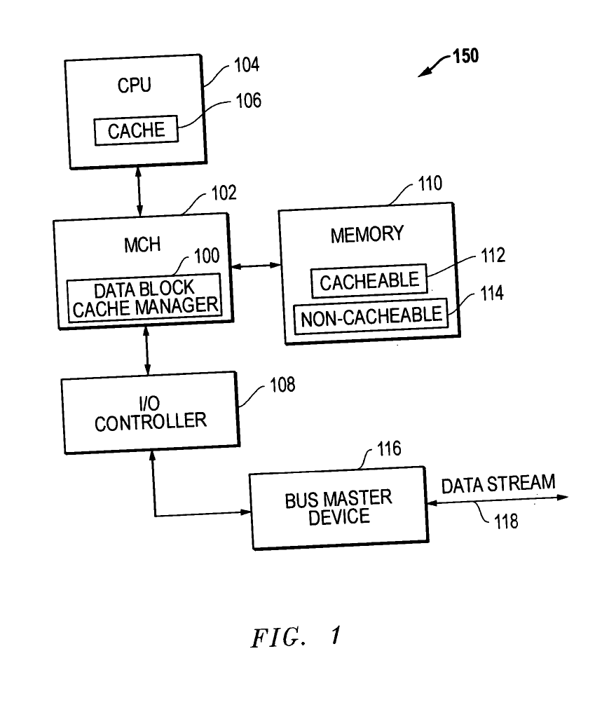

FIG. 1 is a block diagram for an information handling system 150 including a data block cache manager 100 according to the present invention. As depicted, a memory control hub (MCH) 102 includes the data block cache manager 100, and the MCH 102 is coupled to a central processor unit (CPU) or processor 104, a memory 110, and an input/output (I/O) controller 108. The CPU 104 includes an on-chip cache 106 and can operate in at least one low power state. The memory 110 includes memory spaces that can be allocated as cacheable memory 112 or as non-cacheable memory 114. The I/O controller 108 can be coupled to a variety of devices and circuitry within the information handling system 150. As shown, bus master device 116 is coupled to I/O controller 108, and the bus master device 116 is receiving a data stream 118. The data stream 118 can be a wide variety of data streams that may or may not require some processing by the CPU 104. For example, the data stream 118 could include video data, audio data, or both. And the data stream 118 can include a compressed data stream, such as an MPEG2 data stream. It is noted that rather than being implemented with software running on the MCH 102, the data block cache manager 100 may also be, for example, implemented with software running on the CPU 104 as part of the device driver for the bus master device 116. If desired, the data block cache manager 100 could also be implemented with other software and/or hardware solutions while still providing the intelligent data block cache management of the present invention.

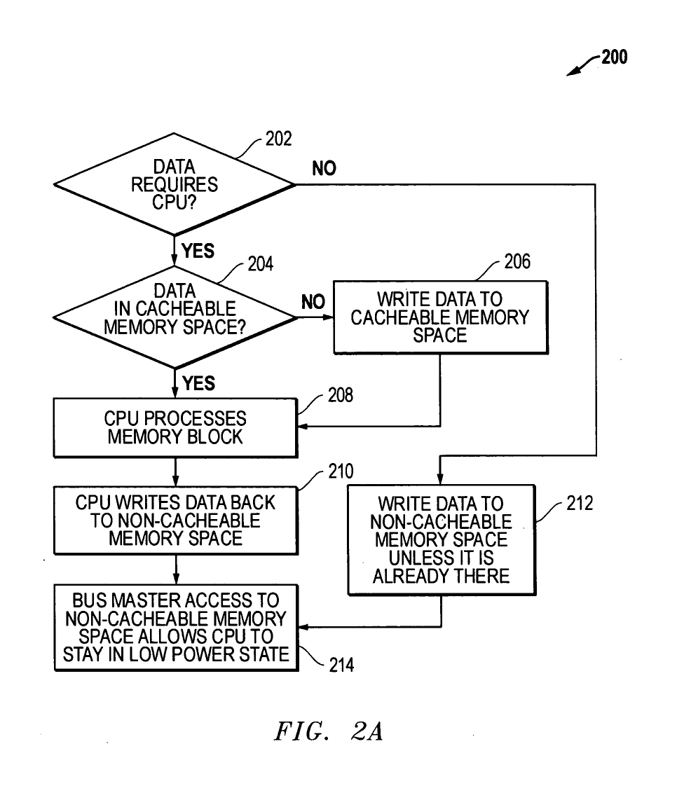

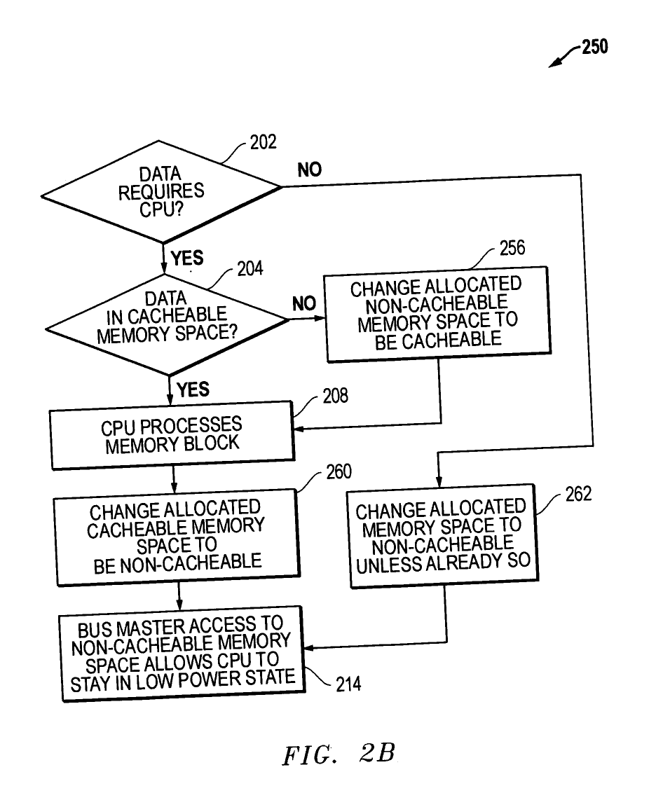

FIG. 2A is a flow diagram for an embodiment 200 in which data is intelligently moved between cacheable memory 112 and non-cacheable memory 114 in order to improve processor power performance with respect to data handling by bus master devices. Process flow for embodiment 200 begins in decision block 202 where a determination is made whether the data requires processing by the CPU or processor 104. If “YES,” then control passes to decision block 204 where a determination is made whether the data is currently written in cacheable memory space 114. If “YES,” then block 208 is reached where the CPU processes the data in the cacheable memory block 112. If the determination is “NO” in decision block 204, the data is first written to cacheable memory space in block 206 before flow moves on to block 208. Next, in block 210, the CPU 104 writes the data back into non-cacheable memory space 114. Finally, in block 214 a bus master device may access non-cacheable memory 114 to obtain the processed data in the non-cacheable memory space thereby allowing the CPU to stay in a low power state. Going back to decision block 202, if the answer is “NO,” block 212 is reached where the data is written to non-cacheable memory space 114, unless the data is already sitting in the non-cacheable memory space. After block 212, process flow then reaches block 214.

FIG. 2B is a flow diagram for an embodiment 250 in which allocated memory spaces are intelligently moved between cacheable and non-cacheable designations in order to improve processor power performance with respect to data handling by bus master devices. Process flow for embodiment 250 begins in decision block 202 where a determination is made whether the data requires processing by the CPU or processor 104. If “YES,” then control passes to decision block 204 where a determination is made whether the data is currently written in cacheable memory space 114. If “YES,” then block 208 is reached where the CPU processes the data in the cacheable memory block 112. If the determination is “NO” in decision block 204, the allocated memory space holding the data is changed from non-cacheable to be cacheable memory space. Flow then moves on to block 208. Next, in block 260, the allocated memory space holding the data is changed back to non-cacheable memory space from cacheable memory space. Finally, in block 214 a bus master device may access non-cacheable memory 114 to obtain the processed data in the non-cacheable memory space thereby allowing the CPU to stay in a low power state. Going back to decision block 202, if the answer is “NO,” block 262 is reached where the allocated memory space holding the data is changed to non-cacheable memory, unless it is already designated as such. Block 214 is then reached.

The present invention may be utilized in a wide variety of systems where bus mastering or other techniques are implemented so that a CPU with the system is not required to act on all data transfers or processing. In such an environment, the present invention allows for data coming into the system to be intelligently managed between cacheable and non-cacheable memory spaces so that the CPU can stay in low power states as much as possible. The present invention is especially useful, for example, with respect to bus master devices that make periodic transfers of small data blocks. The present invention is also useful with respect to bus master devices that are handling data streams that require some encryption or compression processing by the CPU but can then be handled without CPU intervention. Example data streams include compressed video and audio data streams and encrypted communications. Example bus master devices can include video cards and sound cards connected to a system bus. And example system buses are IDE buses, PCI buses, and PCIe (PCI Express) buses. It is noted that with respect to the PCIe bus protocol, data transfers can be identified as requiring or not requiring a CPU cache snoop cycle.

In operation, as discussed above, the data blocks or packets being handled by such devices can be managed by first placing the data in cacheable memory to allow the CPU to perform required processing and then by placing the data in non-cacheable memory for operations not requiring the CPU. Alternatively, the memory space within which the data blocks or packets are being placed can be first designated as cacheable for CPU processing and then designated as non-cacheable once the CPU processing is complete. Thus, by intelligently managing the cached or non-cached nature of the data blocks associated with the data being handled by the bus master device, CPU performance efficiency can be maintained for data processing, and CPU power management efficiency can be maintained for later bus master device processing.

Further modifications and alternative embodiments of this invention will be apparent to those skilled in the art in view of this description. It will be recognized, therefore, that the present invention is not limited by these example arrangements. Accordingly, this description is to be construed as illustrative only and is for the purpose of teaching those skilled in the art the manner of carrying out the invention. It is to be understood that the forms of the invention herein shown and described are to be taken as the presently preferred embodiments. Various changes may be made in the implementations and architectures. For example, equivalent elements may be substituted for those illustrated and described herein, and certain features of the invention may be utilized independently of the use of other features, all as would be apparent to one skilled in the art after having the benefit of this description of the invention.

What is claimed is:

1. A method for managing cacheability of data blocks within an information handling system, comprising:
providing a device coupled through a bus to a processor within an information handling system, the processor having at least one low power state;
receiving a data stream with the device;
determining whether processing by the processor is needed for the data stream;
storing a data block from the data stream in cacheable memory space if processing is needed by the processor;
processing the data block with the processor if processing is needed;
moving the data block to non-cacheable memory space once the processing by the processor is complete; and
accessing the processed data block with the device while allowing the processor to stay in a low power state.

2. The method of claim 1, wherein the device comprises a bus master device.

3. The method of claim 1, wherein the processing step comprises decompression or compression processing.

4. The method of claim 3, wherein the data stream comprises video data, audio data, or both, and wherein the data stream comprises a compressed data stream.

5. The method of claim 1, wherein software operating on the processor performs the determining, storing and moving steps.

6. The method of claim 1, wherein a memory control hub performs the determining, storing and moving steps.

7. The method of claim 1, further comprising performing cache snoop operations when the data block is within cacheable memory space.

8. A method for managing cacheability of data blocks within an information handling system, comprising:
providing a device coupled through a bus to a processor within an information handling system, the processor having at least one low power state;
receiving a data stream with the device;
determining whether processing by the processor is needed for the data stream;
storing a data block from the data stream in memory space;
designating the memory space as cacheable if it is not already designated as cacheable, if processing is needed for the data block;
processing the data block with the processor if processing is needed;
designating the cacheable memory space as non-cacheable memory space once the processing by the processor is complete; and
further processing the processed data block with the device while allowing the processor to stay in a low power state.

9. The method of claim 8, wherein the device comprises a bus master device.

10. The method of claim 8, wherein the processing step comprises decompression or compression processing.

11. The method of claim 8, wherein the data stream comprises video data, audio data, or both, and wherein the data stream comprises a compressed data stream.

12. The method of claim 8, wherein software operating on the processor performs the determining, storing and moving steps

13. The method of claim 8, wherein a memory control hub performs the determining, storing and designating steps.

14. The method of claim 8, further comprising performing cache snoop operations when the data block is within cacheable memory space.

15. An information handling system having data block cacheability management;
a processor having at least one low power mode and an on-chip cache;
a memory having memory spaces capable of being designated as cacheable memory space or non-cacheable memory space;
a device configured to receive and process a data stream including a plurality of data blocks; and
a memory control hub coupled to the processor, the memory and the device, the memory control hub including a data block cache manager configured to cause data blocks from the data stream needing to be processed by the processor to be in cacheable memory space and to cause these data blocks to be in non-cacheable memory space after they are processed;
wherein the processor is allowed to stay in a low power state while the device is accessing the processed data block in the non-cacheable memory space.

16. The information handling system of claim 15, wherein the device comprises a bus master device.

17. The information handling system of claim 15, wherein the memory control hub is further configured to perform snoop operations when a data block is in cacheable memory space.

18. The information handling system of claim 15, wherein the memory control hub is configured to move data blocks between memory space designated as cacheable memory space and non-cacheable memory space depending upon processing needs for the data blocks.

19. The information handling system of claim 15, wherein the memory control hub is configured to change the memory space designation between a cacheable memory space designation and a non-cacheable memory space designation depending upon processing needs for the data blocks.

20. The information handling system of claim 15, further comprising a device driver configured to be operated on the processor and to perform some or all of the operations of the data block cache manager.
